(19) United States
(12) Patent Application Publication
(10) Pub. No.: US 2020/0148887 A1
(43) Pub. Date: May 14, 2020

(54) LUSTER PIGMENT AND METHOD FOR PRODUCING THE SAME

(71) Applicants: Takao TSUKIMORI, Toyota-shi (JP); Akika KAMEI, Kyoto-shi (JP); Tomoe HORI, Kyoto-shi (JP)

(72) Inventors: Takao TSUKIMORI, Toyota-shi (JP); Akika KAMEI, Kyoto-shi (JP); Tomoe HORI, Kyoto-shi (JP)

(73) Assignees: TOYOTA JIDOSHA KABUSHIKI KAISHA, Toyota-shi (JP); OIKE & CO., LTD., Kyoto-shi (JP)

(21) Appl. No.: 16/676,597

(22) Filed: Nov. 7, 2019

(30) Foreign Application Priority Data
Nov. 14, 2018 (JP) 2018-213618

(51) Int. Cl. C09C 1/64; C09C 3/04

(52) U.S. Cl. CPC C09C 1/642; C01P 2002/70; C01P 2004/20; C09C 3/045

(57) ABSTRACT

A method for producing a luster pigment containing a plurality of scaly pigment particles that is capable of suppressing reactions between an aluminum layer as a core layer of each pigment particle and water, even when the luster pigment is exposed to atmosphere containing oxygen or water. The method includes forming a first layer on a surface of a film substrate through deposition of titanium as material, forming a second layer on a surface of the first layer through deposition of aluminum as material, and forming a third layer on a surface of the second layer through deposition of titanium as material, so as to form a stack including the first layer, second layer, and third layer stacked in sequence on the surface of the film substrate, and removing the stack from the film substrate and crushing the removed stack, so as to produce the plurality of scaly pigment particles.

### CROSS REFERENCE TO RELATED APPLICATIONS

The present application claims priority from Japanese patent application JP 2018-213618 filed on Nov. 14, 2018, the content of which is hereby incorporated by reference into this application.

### BACKGROUND

### Technical Field

The present disclosure relates to a luster pigment containing a plurality of scaly pigment particles and a method for producing the same.

### Background Art

For coating bodies and exterior components of automobiles, for example, luster pigments containing pigment particles may occasionally be used. JP 2012-1598 A proposes a luster pigment containing pigment particles that are obtained by surface-treating flaky aluminum particles with a titanate-based coupling agent. When a coating containing such a luster pigment is used for coating, the surface of the coated film can exhibit metallic appearance.

### SUMMARY

However, when pigment particles include coating layers of particles that are treated with a titanate-based coupling agent, since the coating layers are thick, a film coated with a coating including such pigment particles may have an irregular surface, thereby occasionally failing to exhibit sufficiently bright metallic appearance.

The present disclosure has been made in view of the foregoing, and provides a luster pigment capable of exhibiting sufficiently bright metallic appearance and a method for producing the same.

In view of the foregoing, the present disclosure provides a method for producing a luster pigment containing a plurality of scaly pigment particles, the method including forming a first layer on a surface of a film substrate through deposition of titanium material, forming a second layer on a surface of the first layer through deposition of aluminum material, and forming a third layer on a surface of the second layer through deposition of titanium material, so as to form a stack including the first layer, the second layer, and the third layer that are stacked in sequence on the surface of the film substrate, and removing the stack from the film substrate and crushing the removed stack, so as to produce the plurality of scaly pigment particles.

According to the present disclosure, the first and third layers, which are formed through deposition of titanium material, are at least partially oxidized due to a trace of oxygen or water present within a chamber during the deposition, while the second layer, which is formed using aluminum material, becomes an aluminum layer with few oxidized portions.

When only aluminum layers are provided, the layers are oxidized, resulting in degrading brightness. In the present disclosure, since at least the outermost surfaces of the first and third layers are oxidized and turn into those in a passive state (a state in which an oxide film resistant to corrosive actions appears on a metal surface), the aluminum second layer can be protected from oxygen or water. As a result, reactions between the aluminum layer and oxygen or water can be suppressed, so that the metallic luster of the pigment particles can be secured. It should be noted that when titanium oxide layers are directly provided on the opposite sides of the aluminum layer, using a titanium oxide instead of titanium, the aluminum layer is oxidized. In this case, the metallic luster as exhibited by aluminum cannot be exhibited, thereby failing to obtain a luster pigment exhibiting sufficiently bright metallic appearance.

The present specification describes a luster pigment produced using the aforementioned method as the present disclosure. The present disclosure provides a luster pigment containing a plurality of scaly pigment particles, in which each pigment particle includes an aluminum layer as a core layer and titanium-containing layers formed on the opposite sides of the aluminum layer, and the aluminum layer has an unoxidized region.

Herein, the aluminum layer as a core layer corresponds to the aforementioned second layer, while the titanium-containing layers formed on the opposite sides of the second layer correspond to the aforementioned first and third layers.

According to the present disclosure, since in the pigment particle, the aluminum layer as a core layer has an unoxidized region, the metallic luster of the pigment particle can be secured. Further, the titanium-containing layers formed on the opposite sides of the aluminum layer turn into layers in a passive state, so that the aluminum layer can be protected from oxygen or water, for example. As a result, reactions between the aluminum layer and oxygen or water, for example, can be suppressed, so that the metallic luster of the pigment particle can be secured.

Further, the average thickness of each titanium-containing layer may be in the range of 2.0 nm to 11.0 nm, although the average thickness of each titanium-containing layer is not limited thereto, as long as the reactions between the aluminum layer and oxygen or water, for example, can be suppressed.

Herein, when the average thickness of each titanium-containing layer is less than 2.0 nm, the reactions between the aluminum second layer and oxygen or water, for example, cannot be suppressed. Meanwhile, when the average thickness of each titanium-containing layer exceeds 11.0 nm, the average thickness of the pigment particle becomes large. If a coated film containing such pigment particles is formed, portions where the pigment particles overlap one another form large bumps, so that the coated film may have a surface with large irregularities. As a result, it may be difficult for the coated film to exhibit sufficiently bright metallic appearance on its surface.

According to the present disclosure, even when the luster pigment containing the plurality of scaly pigment particles is exposed to atmosphere containing oxygen or water, for example, the reactions between water and the aluminum layers as core layers of the pigment particles can still be suppressed.

### BRIEF DESCRIPTION OF THE DRAWINGS

FIG. 1 is a schematic cross-sectional view of a pigment particle contained in a luster pigment according to the present embodiment:

FIG. 2 is a flowchart illustrating steps of stacking layers through deposition of titanium and aluminum in a method for producing the luster pigment according to the present embodiment:

FIG. 3 shows a STEM image and images showing distributions of aluminum, titanium, and oxygen of a sample according to Example 1;

FIG. 4 shows a STEM image and images showing distributions of aluminum, titanium, and oxygen of a sample according to Example 2:

FIG. 5 is a TEM image of a tissue in a cross section of the sample according to Example 1; and

FIG. 6 is a TEM image of a tissue in a cross section of the sample according to Example 2.

### DETAILED DESCRIPTION

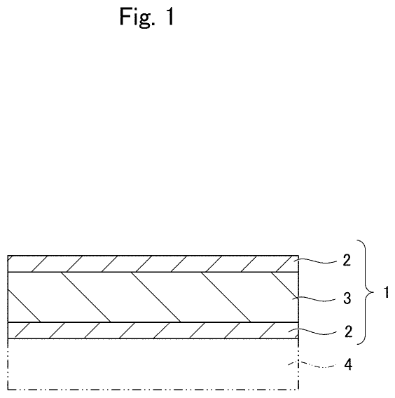

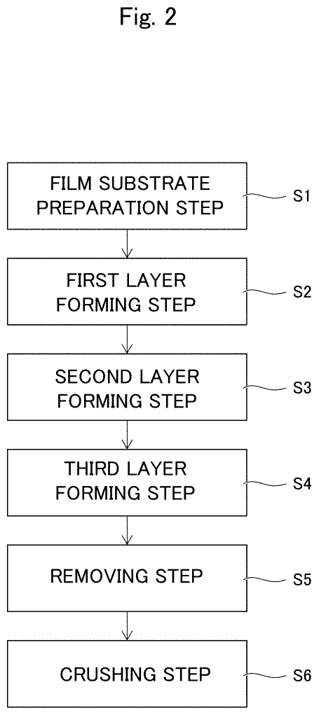

An embodiment according to the present disclosure will be described below with reference to FIG. 1 and FIG. 2. FIG. 1 is a schematic cross-sectional view of a pigment particle 1 contained in a luster pigment according to the present embodiment.

### 1. Regarding Luster Pigment

When a coating containing a luster pigment of the present embodiment is used to form a coated film on the exterior of vehicles or home electric appliances, the luster pigment allows the coated film to exhibit adequate brightness or metallic appearance. Examples of the coating containing the luster pigment include oil-based and water-based coatings. In particular, in the present embodiment, as will be described in Examples, the reactions between water contained in a water-based coating and aluminum layers of the pigment particles (which will be described later) can be suppressed. Therefore, the luster pigment is useful for water-based coatings.

In the present embodiment, the luster pigment contains a plurality of scaly pigment particles 1. Examples of the luster pigment include those containing the plurality of scaly pigment particles 1 dispersed in a dispersion medium and those in a powdery form with aggregates of the plurality of scaly pigment particles 1.

Each pigment particle 1 contained in such a luster pigment is flat, thin, and in a scaly shape. Therefore, when a coated film is formed using the luster pigment, the plurality of pigment particles 1 of the luster pigment can be arranged in the coated film such that the coated film has a smooth surface with few bumps resulting from the plurality of scaly pigment particles 1, in contrast to cases in which pigments containing pigment particles in a granular shape are used. Thus, the coated film can exhibit adequate luster and metallic appearance. Further, examples of the scaly shape of each pigment particle 1 include an oval, round, and polygon.

In the present disclosure, the average thickness of each pigment particle 1 may be in the range of 15 nm to 60 nm. The average thickness of each pigment particle 1 can be measured, such that metal contained in the plurality of pigment particles 1 is measured using fluorescent X-rays. Specifically, standard samples whose average thicknesses are known are measured in advance to identify the relations between the thicknesses and the intensity of the fluorescent X-rays (a calibration-curve method), so that the average thickness of each pigment particle 1 can be measured. The average thicknesses of an aluminum layer 3 and a titanium-containing layer 2, which will be described later, can also be measured in a similar manner.

Further, as shown in FIG. 1, the pigment particle 1 of the present embodiment includes the aluminum layer 3 and titanium-containing layers 2 on the opposite sides of the aluminum layer 3. The aluminum layer 3 (or a second layer, which will be described later) is formed through deposition of aluminum material, and the titanium-containing layers 2 (or first and third layers, which will be described later) on the opposite sides of the aluminum layer 3 are formed through deposition of titanium material.

The aluminum layer 3 is a core layer of the pigment particle 1. The average thickness of the aluminum layer 3 may be in the range of 11 nm to 50 nm. When the average thickness of the aluminum layer 3 is less than 11 nm, it may be difficult to retain the strength of the pigment particle 1. Meanwhile, when the average thickness of the aluminum layer 3 exceeds 50 nm, the average thickness of the pigment particle 1 is increased. Therefore, in a coated film formed, portions where such pigment particles 1 overlap one another may form large bumps. This may degrade the lustrous appearance of the coated film surface.

Further, as the aluminum layer 3 has an unoxidized region, the metallic luster of the pigment particle 1 is maintained.

The titanium-containing layers 2 are provided on the opposite sides of the aluminum layer 3. The average thickness of each titanium-containing layer 2 may be in the range of 2.0 nm to 11.0 nm. When the average thickness of each titanium-containing layer 2 is less than 2.0 nm, the reactions between the aluminum layer 3 and oxygen or water, for example, cannot be suppressed. Meanwhile, when the average thickness of each titanium-containing layer 2 exceeds 11.0 nm, the average thickness of the pigment particle 1 is increased. Therefore, in a coated film formed, portions where such pigment particles 1 overlap one another may form large bumps.

According to the present embodiment, the titanium-containing layers 2 are formed on the opposite sides of the aluminum layer 3 of each pigment particle 1. Since the titanium-containing layers 2 on their interfaces with the aluminum layer 3 are oxidized during a series of steps (which will be described later), and turn into those in a passive state (a state in which an oxide film resistant to corrosive actions is generated on a metal surface), the aluminum layer 3 can be protected from oxygen or water, for example. As a result, the reactions between the aluminum layer 3 and oxygen or water, for example, can be suppressed, so that the metallic luster of the pigment particle 1 can be secured.

When coating layers are formed on the opposite sides of an aluminum layer through silane coupling treatment or the like, as conventionally performed, each coating layer is required to have an average thickness of equal to or greater than 20 nm for suppressing the reactions between the aluminum layer and oxygen or water. When coating layers are formed through wet treatment, such as surface treatment using a silane coupling agent, the reactions between the aluminum layer and water cannot be suppressed, unless each coating layer has an average thickness of equal to or greater than 20 nm. However, in such a pigment particle, when the average thickness of the aluminum layer is 20 nm, for example, the average thickness of the pigment particle is equal to or greater than 60 nm. When the average thickness of the pigment particle exceeds 60 nm, in a coated film formed, portions where such pigment particles overlap one another form large bumps. Further, when light incident on such bumps is diffusely reflected, it may be difficult for the coated film to exhibit metallic appearance on its surface.

In contrast, in the present embodiment, as will be explained in Examples, the average thickness of each titanium-containing layer 2 may be in the range of 2.0 nm to 11.0 nm, which is smaller than those of conventional coating layers, but the titanium-containing layers 2 can still suppress the reactions between the aluminum layer 3 and oxygen or water, for example. Therefore, in the present embodiment, the coated film can still obtain a surface with few bumps even when the pigment particles 1 overlap one another. Thus, the coated film can exhibit metallic lustrous appearance.

Herein, typically, titanium has greater strength and toughness than aluminum. For example, aluminum has a tensile strength of around 100 N/mm² to 200 N/mm², while the tensile strength of titanium is around 400 N/mm². In addition, the maximum elongation of aluminum is around 20%, while that of titanium is around 40%. Thus, since the pigment particle 1 of the present embodiment has the titanium-containing layers 2 formed on the opposite sides of the aluminum layer 3, the pigment particle 1 has greater strength and toughness as compared to aluminum pigment particles with conventional coating layers. Therefore, breaking of the pigment particles 1 into fine pieces during their use can be reduced. As a result, aggregation of the pigment particles 1 contained in a coating can be suppressed. Also, when the coating is sprayed onto a subject to be coated, such as a vehicle, crushing of the pigment particles 1 due to the pressure of spraying the coating onto the subject can be prevented.

### 2. Regarding Method for Producing Luster Pigment

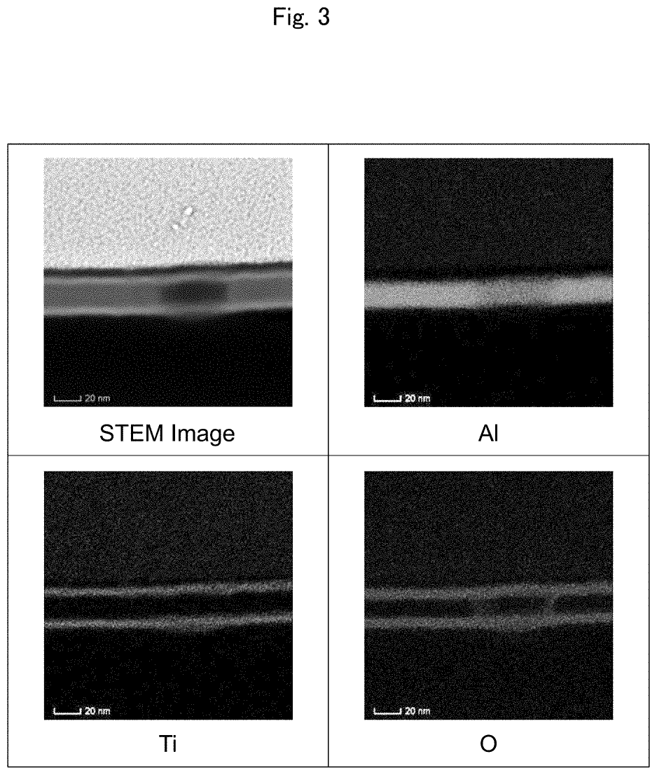

Referring further to FIG. 2 and FIG. 3, a method for producing a luster pigment containing a plurality of scaly pigment particles according to the present embodiment will be described. FIG. 2 is a flowchart illustrating the steps of the method for producing the luster pigment of the present embodiment.

A method for producing a luster pigment of the present embodiment will be described below with reference to the steps shown in FIG. 2.

### <Film Substrate Preparation Step S1>

In a method for producing a luster pigment of the present embodiment, first, a film substrate preparation step S1 is performed. The material of a film substrate used in this step is not particularly limited, as long as the material has excellent removability and heat resistance. Specific examples of the material include polyethylene terephthalate (PET) and polytetrafluoroethylene (PTFE). Further, in the present embodiment, the film substrate to be prepared may include a removing layer formed on its surface where a first layer (which will be described later) is to be formed. Then, after a stack (which will be described later) is formed on a film substrate 4, the stack is immersed in a solvent together with the film substrate 4, thereby dissolving the removing layer, so that the stack can be removed from the film substrate 4.

### <First Layer Forming Step S2>

In the present embodiment, a first layer forming step S2 is performed. In this step, specifically, titanium is melted through high frequency induction heating so as to be deposited on the film substrate 4, so that a first layer is formed.

### <Second Layer Forming Step S3>

Next, a second layer forming step S3 is performed. In this step, a second layer is further formed on the surface of the first layer through deposition of aluminum as material, similarly to step S2.

### <Third Layer Forming Step S4>

Then, a third layer forming step S4 is performed. In this step, a third layer is further formed on the surface of the second layer through deposition of titanium as material, similarly to the first layer forming step S2.

In this manner, a stack including the first, second, and third layers that are stacked in sequence may be formed.

### <Removing Step S5>

Then, a removing step S5 is performed. In this step, the stack is removed from the film substrate 4. The removing method is not particularly limited, as long as the stack can be removed from the film substrate 4 using the method. In the case of the film substrate 4 having the aforementioned removing layer, for example, the film substrate 4 is immersed in a dissolving solution together with the stack, thereby dissolving the removing layer of the film substrate 4, so that the stack can be removed (separated) from the film substrate 4. The dissolving solution is not particularly limited, as long as it does not react with the stack and is capable of dissolving the removing layer. Further, it is also possible to remove the stack from the film substrate 4 by dissolving the film substrate 4. The obtained stack includes the first, second, and third layers that are stacked in sequence.

### <Crushing Step S6>

Next, a crushing step S6 is performed. The crushing method is not particularly limited, as long as the stack can be crushed using the method. For example, ultrasound waves may be applied to a dispersion liquid containing the stack removed from the film substrate 4 so as to crush the stack. Then, the luster pigment containing the plurality of scaly pigment particles 1 is obtained.

Then, the pigment particles 1 dispersed in the dispersion liquid after the crushing are separated from the dispersion liquid through centrifugal separation or suction filtration. Aggregates of separated pigment particles 1 are dried, so that a powdery luster pigment can be obtained.

In this manner, the luster pigment containing the plurality of scaly pigment particles 1 can be obtained. Each pigment particle 1 of the luster pigment includes the aluminum layer 3 as a core layer and the titanium-containing layers 2 formed on the opposite sides of the aluminum layer 3, as shown in FIG. 1. Since in the interfaces between the aluminum layer 3 and the titanium-containing layers 2 formed on the opposite sides of the aluminum layer 3, the titanium-containing layers 2 are oxidized during the series of steps, and turn into those in a passive state (a state in which an oxide film resistant to corrosive actions is generated on a metal surface), the aluminum layer 3 can be protected from oxygen or water, for example. As a result, the reactions between the aluminum of the aluminum layer 3 and oxygen or water, for example, can be suppressed.

### EXAMPLES

The present disclosure will be described in further detail below by way of Examples, but the present disclosure is not limited thereto.

### Example 1

A luster pigment was prepared through a series of the following steps. In the present example, first, a film substrate with a removing layer formed thereon was prepared. The body of the film substrate contained polyethylene terephthalate (PET), and the removing layer contained cellulosic resin. Then, a first layer was formed on the film substrate through vacuum deposition of titanium as material.

Next, a second layer was formed on the first layer through vacuum deposition of aluminum as material.

Then, under the same conditions as those for forming the first layer, a third layer was formed on the second layer through vacuum deposition of titanium as material. Then, a stack including the first, second, and third layers that were stacked in sequence was obtained.

Next, the removing layer of the film substrate, on which the stack was formed in the aforementioned manner, was dissolved in an organic solvent (herein, propylene glycol monomethyl ether) that is capable of dissolving cellulosic resin, so that the stack was removed from the film substrate.

Then, the removed stack was crushed until particles with a target average particle size were obtained. The stack was crushed through application of ultrasound waves to the dispersion liquid containing the stack. In this manner, the dispersion liquid with a plurality of scaly pigment particles dispersed therein was obtained. Thus, the sample of Example 1 was obtained.

### Examples 2 and 3

Under substantially the same conditions as those for forming the sample of Example 1, samples of Examples 2 and 3 were prepared. As will be described later, the average thicknesses of the first and third layers of each pigment particle of the samples of Examples 2 and 3 were different from those of Example 1.

### Comparative Example 1

In the same manner as the sample of Example 1 was prepared, a sample of Comparative Example 1 was prepared. Comparative Example 1 and Example 1 are different in that in Comparative Example 1, first and third layers were not formed.

### [Measurement of Average Thickness and Observation of Tissue in Cross Section]

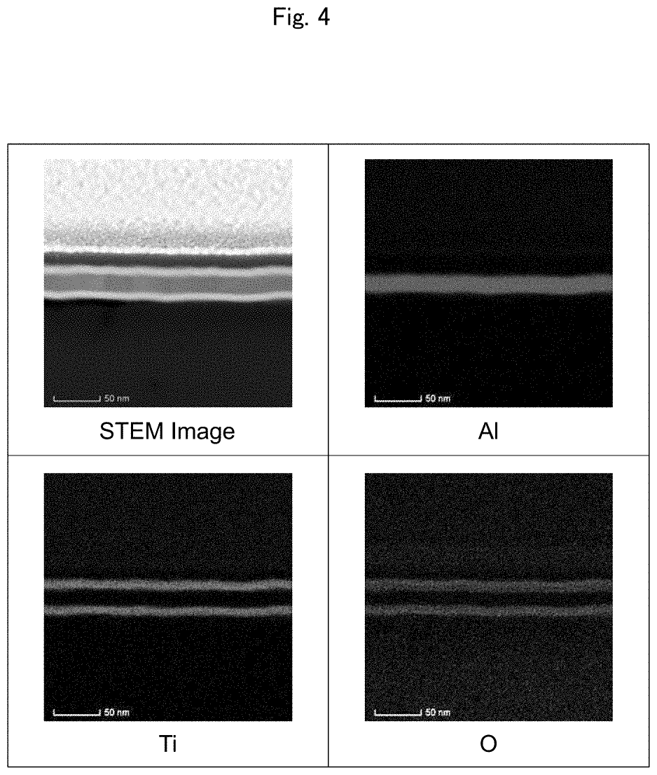

The average thickness of each pigment particle in the samples of Examples 1 to 3 and Comparative Example 1 was measured such that elements of the pigment particles were measured through application of fluorescent X-rays thereto. Specifically, standard samples, whose average thicknesses are known, were measured in advance so as to identify the relations between the thicknesses and the intensity of the fluorescent X-rays (a calibration-curve method), so that the average thickness of each pigment particle was measured. The average thicknesses of the aluminum layer and titanium-containing layer can also be measured in a similar manner. Further, a tissue in a cross section of each sample of Examples 1 and 2 was observed. The STEM images of Examples 1 and 2 are shown in FIG. 3 and FIG. 4, respectively.

### [Results 1]

In the pigment particle in the sample of Example 1, the average thicknesses of the titanium-containing layers were 4.0 nm and 2.5 nm, and that of the aluminum layer was 16.5 nm. In the pigment particle in the sample of Example 2, the average thicknesses of the titanium-containing layers were 5.9 nm and 6.7 nm, and that of the aluminum layer was 18.3 nm. In the pigment particle in the sample of Example 3, the average thicknesses of the titanium-containing layers were 10.2 nm and 8.0 nm, and that of the aluminum layer was 20.2 nm. In the pigment particle of Comparative Example 1, the thickness of the aluminum layer was 25.6 nm.

### [Examination of Elements Distribution]

Distributions of aluminum, titanium, and oxygen in the cross section of the pigment particle of each sample obtained in Examples 1 and 2 were examined using the STEM-EDX (Scanning Transmission Electron Microscope-Energy Dispersive X-ray Analysis).

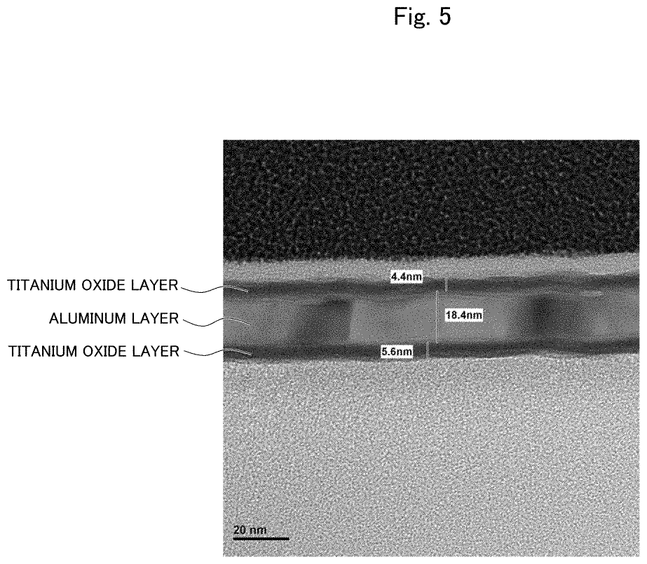

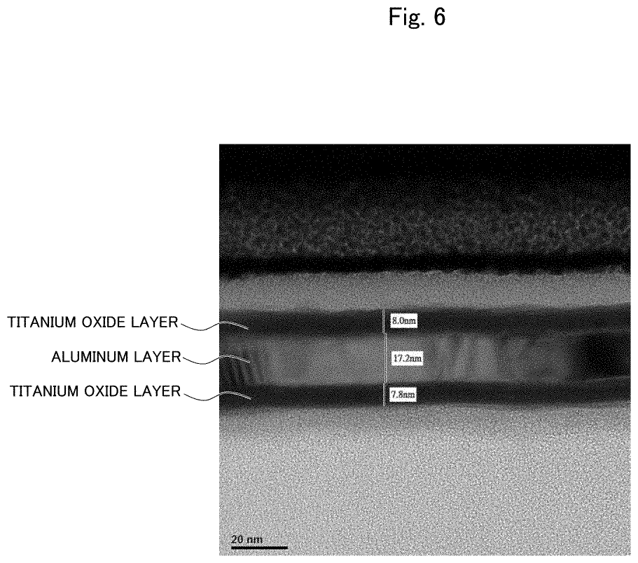

The results of the examination conducted on Examples 1 and 2 are shown in FIG. 5 and FIG. 6, respectively. FIG. 5 is a TEM image of Example 1 illustrating distributions of aluminum, titanium, and oxygen. FIG. 6 is a TEM image of Example 2 illustrating distributions of aluminum, titanium, and oxygen.

### [Results 2]

As can be seen from FIG. 5 and FIG. 6, in the samples of Examples 1 and 2, layers with titanium and oxygen distributed therein on the opposite sides of a layer with aluminum distributed therein were observed in each of the pigment particles. This proves that each pigment particle of Examples 1 and 2 has the titanium-containing layers formed on the opposite sides of the aluminum layer as a core layer, the titanium-containing layers being oxidized at least on their interfaces with the aluminum layer. It can also be confirmed that almost no oxygen was detected in the aluminum layers of Examples 1 and 2.

Next, reactions between water and each of the pigment particle samples of Examples 1 to 3 and Comparative Example 1 were examined under the following Test Conditions 1 to 3.

### [Preparation of Test Solution for Water Reaction Testing]

### (Test Condition 1)

Samples of Examples 1 to 3 and Comparative Example 1 were individually put in containers together with propylene glycol monomethyl ether and water, so as to prepare test solutions, each test solution having a solid concentration of each sample of 3.16% by mass and a water percentage of 10% by mass. The types and solid concentrations of pigment particles used, and water percentage are shown in Table 1.

### (Test Condition 2)

In a similar manner to the test solutions that were prepared under Test Condition 1, test solutions were prepared under Test Condition 2. Test Condition 2 was different from Test Condition 1 in the solid concentration of each sample and water percentage. Specifically, as shown in Table 1, the solid concentration of each sample and water percentage of each test solution under Test Condition 2 were 2.48% by mass and 30% by mass, respectively.

### (Test Condition 3)

In a similar manner to the test solutions that were prepared under Test Condition 1, test solutions were prepared under Test Condition 3. Test Condition 3 was different from Test Condition 1 in the solid concentration of each sample and water percentage. Specifically, as shown in Table 1, the solid concentration of each sample and water percentage of each test solution under Test Condition 3 were 1.78% by mass and 50% by mass, respectively.

Table 1 shows the results of water reaction testing conducted on Examples 1 to 3 and Comparative Example 1 under Test Conditions 1 to 3.

### [Water Reaction Testing]

The test solutions of Examples 1 to 3 and Comparative Example 1 were hermetically sealed in containers and left at room temperature for seven days. Then, the differential pressure between the ambient pressure and the pressure inside each container was measured. In addition, the appearance of each sample (or each pigment particle) in each test solution was observed to confirm the presence of aggregation of pigment particles dispersed in each test solution. The results are shown in Table 1.

TABLE 1

| | | Solid con- | Water | Differ- | |
|---|---|---|---|---|---|
| | | centration | percent- | ential | |
| Type of | Test | of pigment | age of | pressure | |
| pigment | condi- | particle (% | solvent (% | after seven | Appear- |
| particle | tion | by mass) | by mass) | days (kPa) | ance |
| Example 1 | 1 | 3.16 | 10 | 1.0 | unchanged |
| | 2 | 2.48 | 30 | 1.4 | unchanged |
| | 3 | 1.78 | 50 | 2.6 | unchanged |
| Example 2 | 1 | 3.16 | 10 | 0.4 | unchanged |
| | 2 | 2.48 | 30 | 0.4 | unchanged |
| | 3 | 1.78 | 50 | 0.8 | unchanged |
| Example 3 | 1 | 3.16 | 10 | −0.1 | unchanged |
| | 2 | 2.48 | 30 | −0.2 | unchanged |
| | 3 | 1.78 | 50 | 0.8 | unchanged |
| Comparative | 1 | 3.16 | 10 | 0.1 | unchanged |
| Example 1 | 2 | 2.48 | 30 | 3.7 | unchanged |
| | 3 | 1.78 | 50 | 20.8 | whitened/ |
| | | | | | gelated |

### [Results 3]

As compared to Examples 1 to 3, in the pigment particle of Comparative Example 1 having only an aluminum layer, the differential pressure as well as the water percentage increased. This is considered to have been caused by gas generated through reactions between aluminum and water. Further, in Comparative Example 1 under Text Condition 3, which has the highest water percentage, the pigment particle was whitened and gelated. This is considered to have occurred because the aluminum layer and water reacted with each other, thereby having altered the aluminum to an aluminum oxide.

In contrast, in the pigment particles of Examples 1 to 3, each having first and third titanium-containing layers, neither appearance change nor aggregation of the pigment particles was found even after seven days have elapsed. This was likely because the titanium-containing layers prevented water from entering the aluminum layer. In addition, in the pigment particles having titanium-containing layers, an increase in the differential pressure was able to be suppressed. This was because the titanium-containing layers were oxidized and turned into layers in a passive state, so that the oxidized titanium-containing layers in a passive state were able to suppress the reactions between the aluminum layers and water.

Moreover, as can be seen from Examples 1 to 3, when the aforementioned effective results were obtained, the average thickness of each of the titanium-containing layers provided on the opposite sides of the aluminum layer was in the range of 2.5 nm to 10.2 nm. It should be noted that when the average thickness of each titanium-containing layer is less than 2.0 nm, the reactions between the aluminum layer and oxygen or water, for example, cannot be suppressed. Meanwhile, it is known to be difficult to obtain a specular surface when the average thickness of each titanium-containing layer exceeds 11.0 nm, because the average thickness of the pigment particle becomes large, resulting in forming bumps in portions where the pigment particles overlap one another on the surface. Considering the foregoing, the average thickness of each titanium-containing layer may be in the range of 2.0 nm to 11.0 nm.

Although the embodiment of the present disclosure has been detailed, the present disclosure is not limited thereto, and various design changes can be made without departing from the spirit of the present disclosure recited in the claims.

What is claimed is:

1. A method for producing a luster pigment containing a plurality of scaly pigment particles, the method comprising:
forming a first layer on a surface of a film substrate through deposition of titanium as material, forming a second layer on a surface of the first layer through deposition of aluminum as material, and forming a third layer on a surface of the second layer through deposition of titanium as material, so as to form a stack including the first layer, the second layer, and the third layer that are stacked in sequence on the surface of the film substrate; and
removing the stack from the film substrate and crushing the removed stack, so as to produce the plurality of scaly pigment particles.

2. A luster pigment containing a plurality of scaly pigment particles, wherein
each pigment particle includes an aluminum layer as a core layer and titanium-containing layers formed on opposite sides of the aluminum layer, and
the aluminum layer has an unoxidized region.

3. The luster pigment according to claim 2, wherein an average thickness of each titanium-containing layer is in a range of 2.0 nm to 11.0 nm.
